(19) United States
(12) Patent Application Publication
(10) Pub. No.: US 2022/0209286 A1
(43) Pub. Date: Jun. 30, 2022

(54) AEROSOL DEPOSITION OF SOLID ELECTROLYTE MATERIALS

(71) Applicant: The Government of the United States of America, as represented by the Secretary of the Navy, Arlington, VA (US)

(72) Inventors: Scooter David Johnson, Hyattsville, MD (US); Alexander C. Kozen, Mount Ranier, MD (US)

(73) Assignee: The Government of the United States of America, as represented by the Secretary of the Navy, Arlington, VA (US)

(21) Appl. No.: 17/565,429

(22) Filed: Dec. 29, 2021

Related U.S. Application Data
(60) Provisional application No. 63/131,862, filed on Dec. 30, 2020.

(51) Int. Cl. H01M 10/0562

(52) U.S. Cl. CPC H01M 10/0562; H01M 10/0525

(57) ABSTRACT

A method of: forming an aerosol of a powder comprising one or more of lithium, germanium, phosphorus, sulfur, boron, fluorine, chlorine, bromine, aluminum, nitrogen, arsenic, niobium, titanium, vanadium, molybdenum, manganese, zinc, hafnium, and nickel and directing the aerosol at a substrate at a velocity that forms a film of the powder on the substrate. The method makes an article having an ionic conductor in the form of a film at most 0.5 mm thick.

### CROSS-REFERENCE TO RELATED APPLICATION

This application claims the benefit of U.S. Provisional Application No. 63/131,862, filed on Dec. 30, 2020. The provisional application and all other publications and patent documents referred to throughout this nonprovisional application are hereby incorporated herein by reference each in their respective entirety.

### TECHNICAL FIELD

The present disclosure is generally related to solid sulfide-based electrolyte materials.

### DESCRIPTION OF RELATED ART

Solid electrolyte materials have several advantages over traditional liquid electrolytes, the most important being increased chemical and thermal stability. While many solid electrolytes exhibit lower ionic conductivity than their liquid counterparts, recently, sulfide-based solid electrolyte materials such as Li₂₂GeP₂S₁₂ (LGPS) have been shown to have comparable lithium-ion conductivity (σ_{Li}>10⁻³ S cm⁻¹) at room temperature. Unfortunately, these materials are extremely air-sensitive, which hampers processing and ultimate battery fabrication. It is desirable for the electrolyte to be dense and well-contacted to the top and bottom electrodes for low interfacial impedance and to prevent metal dendrite formation. It is also desirable to form the electrolyte as thin as possible, allowing maximal energy and power density of the full battery, thereby allowing the battery to perform better with improved size, weight, and power.

Typical fabrication of the LGPS and similar sulfide-based layers is done by taking synthesized powder and pressing the powder in a hydraulic press under controlled atmospheric conditions to achieve high-density pellet. Annealing is often required to further densify the pellet, which may cause material degradation. The pressed pellet is then dry lapped as thin as possible. Due to the stresses on the pellet during lapping, achieving a pellet thickness of less than about 0.2 mm is extremely challenging. A second hurdle to integration is achieving a high-contact bond with the electrodes. The electrolyte can be compression adhered onto the contact surface, however, cracking and poor contact often occur which severely degrades the final performance.

### BRIEF SUMMARY

Disclosed herein is an article comprising: an ionic conductor comprising one or more of lithium, germanium, phosphorus, sulfur, boron, fluorine, chlorine, bromine, aluminum, nitrogen, arsenic, niobium, titanium, vanadium, molybdenum, manganese, zinc, hafnium, and nickel. The ionic conductor is in the form of a film at most 0.5 mm thick. The ionic conductor is made by aerosol deposition of a lithium-germanium-phosphorous-sulfur powder.

Also disclosed herein is a method comprising: forming an aerosol of a powder comprising one or more of lithium, germanium, phosphorus, sulfur, boron, fluorine, chlorine, bromine, aluminum, nitrogen, arsenic, niobium, titanium, vanadium, molybdenum, manganese, zinc, hafnium, and nickel and directing the aerosol at a substrate at a velocity that forms a film of the powder on the substrate.

### BRIEF DESCRIPTION OF THE DRAWINGS

A more complete appreciation will be readily obtained by reference to the following Description of the Example Embodiments and the accompanying drawings.

FIG. 1 schematically illustrates an apparatus for performing the disclosed method.

FIG. 2 shows a photograph of the apparatus.

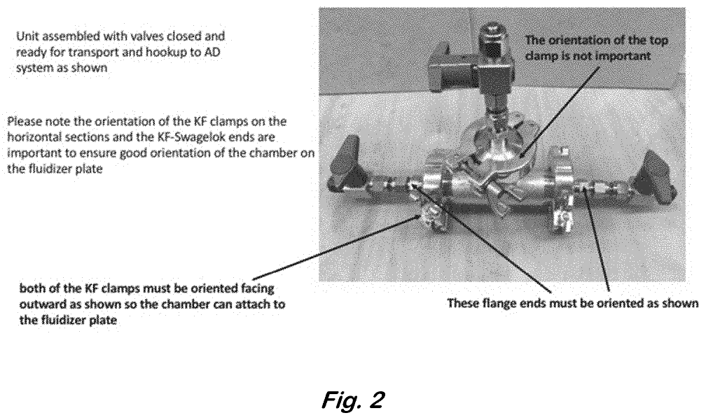

FIG. 3 shows an SEM of a thin Li₁₀GeP₂S₁₂ film deposited onto an Au-coated Si substrate by aerosol deposition. Argon carrier gas was used for the deposition.

FIG. 4 shows a focused ion beam cross-section of the LGPS material.

### DETAILED DESCRIPTION OF EXAMPLE EMBODIMENTS

In the following description, for purposes of explanation and not limitation, specific details are set forth in order to provide a thorough understanding of the present disclosure. However, it will be apparent to one skilled in the art that the present subject matter may be practiced in other embodiments that depart from these specific details. In other instances, detailed descriptions of well-known methods and devices are omitted so as to not obscure the present disclosure with unnecessary detail.

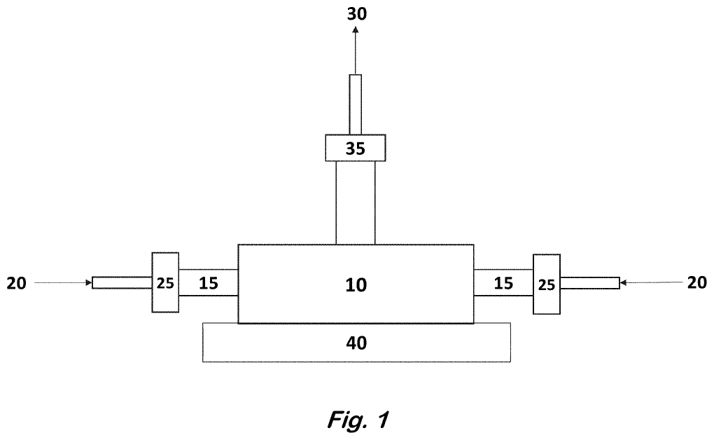

The disclosed method is a process for depositing sulfide-based lithium electrolyte material formed by aerosol deposition (AD). The method uses synthesized dry powder as input feedstock. The powder is loaded into a specialized sealable chamber referred to as the aerosol chamber (AC) 10 (FIG. 1) under controlled atmospheric conditions. The horizontal ports 15 located on the side of the AC 10 are connected to a carrier gas 20, which could be nitrogen, argon, helium, carbon dioxide, oxygen, dry air, or any other desirable carrier gases. The gas 20 is controlled by valves 25. The AC 10 is connected to the deposition chamber (DC) 30 via the top valve 35. A fluidized bed 40 vibrates the AC 10. Inside the DC 30 substrates are mounted to a carrier that translates across the mouth of a spray nozzle that is connected to the AC 10, thereby drawing the powder from the AC 10 and into the DC 30 to impinge onto the substrates.

The powder may be a glass or a crystalline material, and may be homogenous in size or comprised of a spread of different particle sizes (anywhere from 1 nm-100 μm diameter). The powder may be homogenous in composition or could have either a graded or a core-shell composition. The shell could be comprised of materials previously deposited using vapor phase or liquid-phase synthesis techniques such as atomic layer deposition, chemical vapor deposition, sol-gel synthesis, and precipitation-synthesis. The feedstock powder may be comprised of only LGPS (electrolyte) powder or may be mixed LGPS/cathode particle powder. The cathode material may be, for example, lithium nickel cobalt manganese oxide, lithium nickel cobalt aluminum oxide, or lithium iron phosphate. The feedstock powder could also be comprised of a mixed anode-electrolyte powder. The anode may be for example, carbon, Li metal, Na metal, Al metal, Si, or alloys of these elements.

Reactive gasses can be introduced with the particle feed in order to chemically modify the particles before they impact the surface during the aerosol process. This could be done for the purposes of incorporating additional dopants into the resulting film, or to improve particle yields by modification of the sticking coefficient or by modulation of electrostatic dispersion.

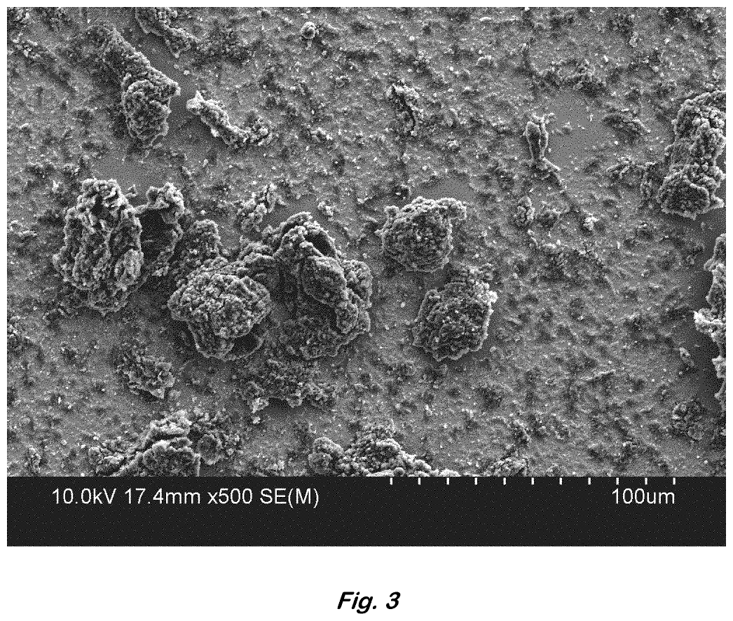

In the deposition process, the AD system is pumped to a vacuum of about 0.1 Torr or less. The valves on the AC are opened and the AC is similarly evacuated. The AC is vibrated to fluidize the powder while the carrier gas enters the AC while the evacuation pumps continue to pump on the DC. The pressure differential that results drives the powder-entrained gas from the AC and into the DC via the spray nozzle. The powder and gas are ejected from the spray nozzle and impact with the substrate. The result shown in FIG. 3 is a densely-compacted film <0.2 mm However, the thickness may be less than 0.5 mm, 0.4 mm, 0.3 mm, 0.2 mm, or 0.1 mm. In this film Li₁₀GeP₂S₁₂ (LGPS) material was used as the feedstock to form the films onto Si substrates coated with either Au, V₂O₅, or Pt. The SEM image in FIG. 3 shows the deposited LGPS film onto a gold-coated silicon substrate.

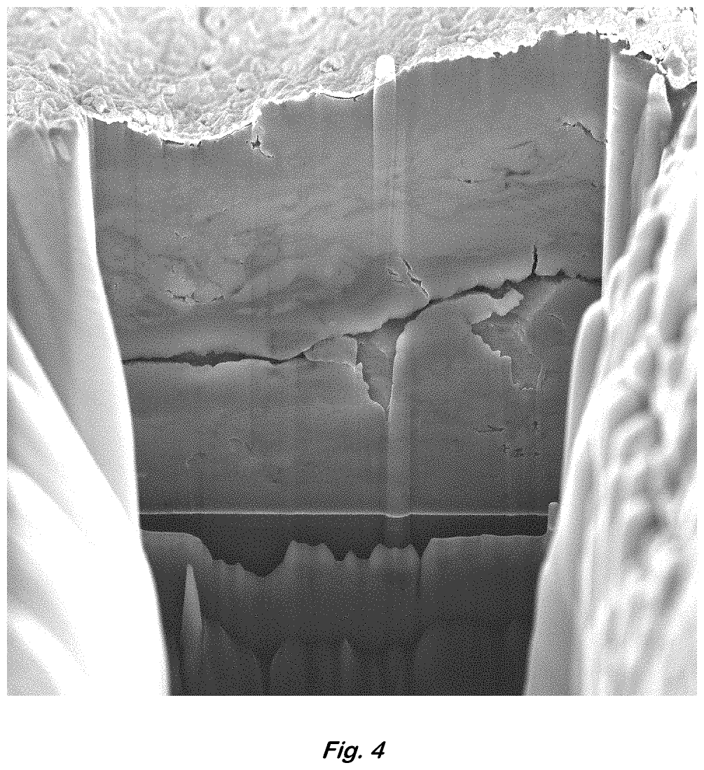

The image shows evidence of a thin film, with large residual particles present. FIG. 4 shows a focused ion beam cross-section of the LGPS material. The total thickness of the LGPS film was ˜20 microns.

The disclosed method overcomes the problem of forming and integrating sulfide-based air-sensitive electrolyte materials such as LGPS into low-profile battery structures. A lithium battery may comprise an anode, a cathode, and the presently described material as a solid electrolyte. Typically, bulk LGPS electrolyte materials must be formed in specialized hydraulic press systems under a controlled atmosphere and lapped to thin. Annealing is often needed to fully densify the bulk pellet. Since the LGPS material must be kept in a controlled atmosphere, pressing and lapping the bulk pucks is a technological hurdle for forming and contacting the electrolyte for forming low-profile solid-state batteries. The present method overcomes these hurdles by (1) forming a solid dense film at room temperature so no annealing is needed which can degrade the material, (2) forming the films in an inert atmosphere so that no degradation of the LGPS material occurs, and (3) forming the dense film at a desired thickness from submicron to several tens of microns in thickness.

Many modifications and variations are possible in light of the above teachings. It is therefore to be understood that the claimed subject matter may be practiced otherwise than as specifically described. Any reference to claim elements in the singular, e.g., using the articles “a”, “an”, “the”, or “said” is not construed as limiting the element to the singular.

What is claimed is:

1. An article comprising:
an ionic conductor comprising one or more of lithium, germanium, phosphorus, sulfur, boron, fluorine, chlorine, bromine, aluminum, nitrogen, arsenic, niobium, titanium, vanadium, molybdenum, manganese, zinc, hafnium, and nickel;
wherein the ionic conductor is in the form of a film at most 0.5 mm thick; and
wherein the ionic conductor is made by aerosol deposition of a lithium-germanium-phosphorous-sulfur powder.

2. The article of claim 1, wherein the ionic conductor is a lithium, germanium, phosphorus, and sulfur-based ionic conductor.

3. The article of claim 1, wherein the powder comprises Li₁₀GeP₂S₁₂.

4. The article of claim 1, wherein the powder comprises Li₂₂GeP₂S₁₂.

5. The article of claim 1, wherein the article is a lithium battery.

6. A method comprising:
forming an aerosol of a powder comprising one or more of lithium, germanium, phosphorus, sulfur, boron, fluorine, chlorine, bromine, aluminum, nitrogen, arsenic, niobium, titanium, vanadium, molybdenum, manganese, zinc, hafnium, and nickel; and
directing the aerosol at a substrate at a velocity that forms a film of the powder on the substrate.

7. The method of claim 6, wherein the powder is a lithium-germanium-phosphorous-sulfur powder.

8. The method of claim 6, wherein the powder comprises Li₁₀GeP₂S₁₂.

9. The method of claim 6, wherein the powder comprises Li₂₂GeP₂S₁₂.
